(19) United States
(12) Patent Application Publication
(10) Pub. No.: US 2018/0136462 A1
(43) Pub. Date: May 17, 2018

(54) ROTATING HEAD-UP DISPLAY DEVICE

(71) Applicant: E-LEAD ELECTRONIC CO., LTD., CHANGHUA (TW)

(72) Inventor: Stephen CHEN, CHANGHUA (TW)

(21) Appl. No.: 15/352,500

(22) Filed: Nov. 15, 2016

(51) Int. Cl. G02B 27/01; G06F 3/16; B60K 35/00

(52) U.S. Cl. CPC G02B 27/0101; G06F 3/167; G02B 27/0149; B60K 2350/2052; G02B 2027/0196; G02B 2027/0138; G02B 2027/0118; B60K 35/00

(57) ABSTRACT

The present invention relates to a rotating head-up display device, which includes a base, a rotating module, a display module and a reflective module,

The fixed portion of the rotating module fixed to the base and the rotating portion of the rotating module fixed to the display module are provided as image rotating mechanism, and the adjustment module is provided to operate for rotating and projecting enlarged images, to thereby conveniently rotate images corresponding to horizontal screen and vertical screen of a smartphone or a tablet.

### BACKGROUND OF THE INVENTION

### a) Field of the Invention

The present invention relates to a rotating head-up display device and, more particularly, to a rotating head-up display device for rotating and enlarging images, to thereby conveniently rotate images corresponding to horizontal screen and vertical screen of a smartphone or a tablet.

### b) Description of Prior Art

In recent years, there are many external head-up displays for installing in vehicles in the market. The functions of these head-up displays are not only simply displaying car speed and engine speed, but also displaying water temperature, throttle position, oil, speed warning, reversing image, battery voltage, even integrating a speed radar together.

Some products are emphasized for their quick installation, they are provided to directly connect to in-vehicle computer without additional cables. It is convenient for drivers that adding data, such as navigation system and distance between rear and the front vehicles, for being displayed by the head-up displays in some luxury vehicles.

Price of external head-up display devices in the market are from several hundred dollars for those with simple functions, to more than ten thousand dollars for good quality and various functions.

There are many kinds of external head-up displays with various functions, related technologies may be referred to cited references TW M421266, M292511, M521565, M245104, M437035, M468454, TW publication number 201400329, CN authorized announcement number 204998443 U, most of the cited references have rotating and fine adjustment functions, however, the following problems exist in use:

1. In the cited references, some of them are only vehicle display screen, for example, the display in TW M421266, although it may be adjusted in three directions, the rotating and fine adjustment mechanism is mainly set for people sitting in rear seat to conveniently watch it and adjusting its angle, this kind of display screen cannot used as a head-up display device.

2. Recently, in the market, head-up display devices includes mechanism for rotating and adjusting, but most of them could only provide to slightly rotate and adjust watching angle, they could not rotate images corresponding to horizontal screen and vertical screen of a smartphone or a tablet, so it is not convenient for users to watch driving information and images.

### SUMMARY OF THE INVENTION

In order to solve the above problems, the inventor of the present invention finally completed the rotating head-up display device of the present invention after numerous improvements, namely, the object of the present invention is to provide a rotating head-up display device for rotating and enlarging images, to thereby conveniently rotate images corresponding to horizontal screen and vertical screen of a smartphone or a tablet.

To achieve the object, the rotating head-up display device of the present invention, including:
a base, a containing space is set inside it, and a circuit board is set on it;
a rotating module, which includes a fixed portion and a rotating portion, the fixed portion is fixedly connected to the base;
a display module, which is electrically connected to the circuit board, the display module is fixedly connected to the rotating portion, the display module is provided to project images;
a reflective module, which is provided to reflect the images projected by the display module.

The circuit board includes an adjustment module, the adjustment module is provided to rotate and enlarge images after receiving a rotating signal.

The reflective module is a reflective film with translucent semi-reflective effect.

The reflective module includes a reflective sheet and a base plate, the reflective sheet is fixed on the base plate, an adhesive set on a bottom side of the base plate is attached onto a windshield, the reflective sheet is a concave mirror with translucent semi-reflective effect.

The circuit board further includes a keypad, the keypad is provide to operate the rotating head-up display device.

The circuit board further includes a camera input port, the camera input port is provided to connect to a camera installed on a vehicle, to thereby capture images around the vehicle.

The circuit board further includes a light sensing module, the light sensing module is provided to adjust brightness of the display module.

The circuit board further includes a speaker module, the speaker module is provided to inform drivers of voice messages.

The circuit board further includes a wireless module, the wireless module is provided to receive signal data wirelessly send from an electric device.

The circuit board further includes a connection terminal, the connection terminal is provided to receive signal information send from an electric device by cable.

### BRIEF DESCRIPTION OF THE DRAWINGS

FIG. 1 is a three-dimensional schematic diagram of the present invention;

FIG. 2 is a sectional schematic diagram of the present invention;

FIG. 3 is a schematic diagram of rotation of the present invention;

FIG. 4 is a three-dimensional schematic diagram of the reflective module of the present invention;

FIG. 5 is a block diagram of the present invention;

FIG. 6 is a schematic diagram of embodiment of the present invention;

FIG. 7 is a schematic diagram (1) of image rotating of the present invention;

FIG. 8 is a schematic diagram (2) of image rotating of the present invention;

FIG. 9 is a schematic diagram (3) of image rotating of the present invention; and

FIG. 10 is a schematic diagram (4) of image rotating of the present invention.

### DETAILED DESCRIPTION OF THE INVENTION

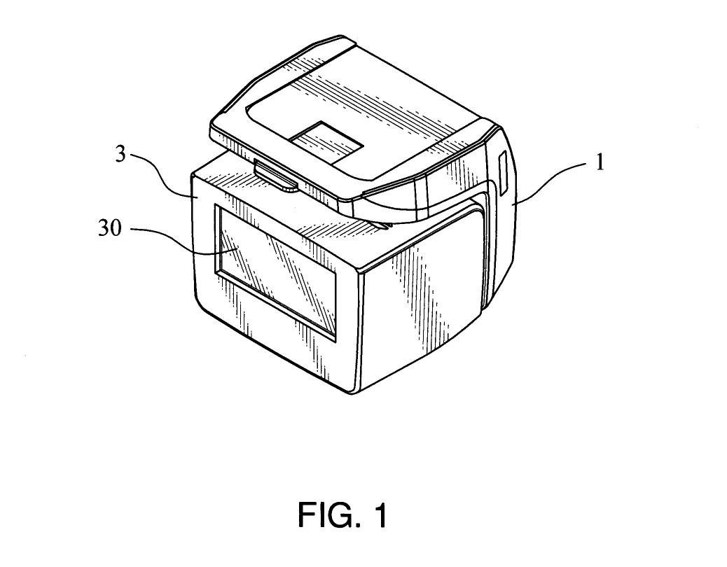

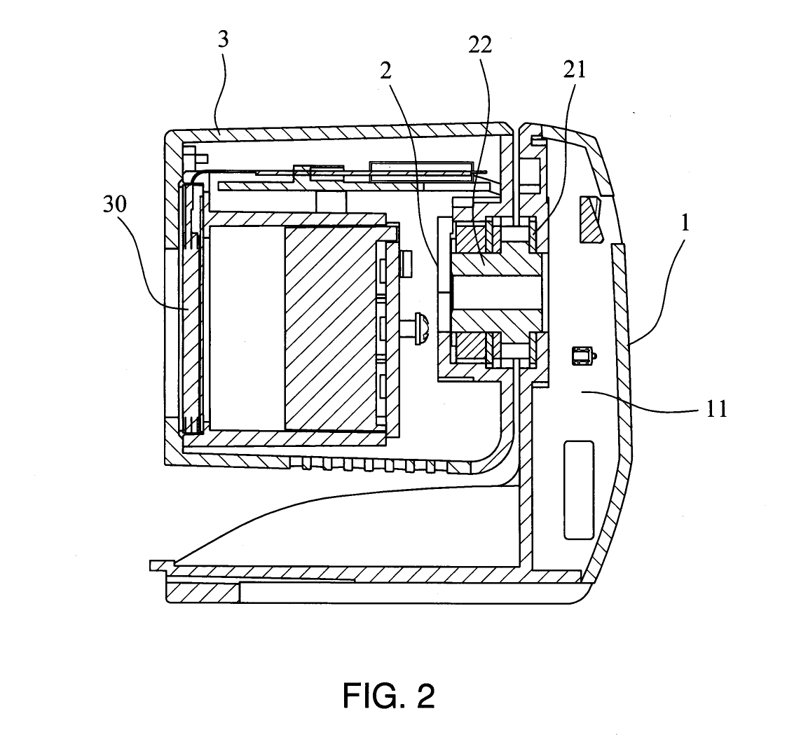

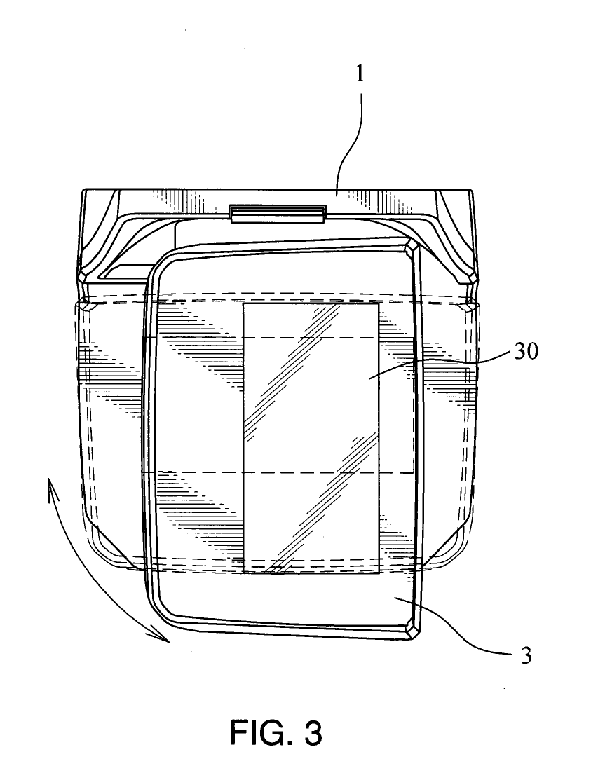

Please refer to FIG. 1 to FIG. 6, the rotating head-up display device of the present invention, including:
a base 1, a containing space 11 is set inside it, and a circuit board 12 is set on it, the circuit board 12 includes a processor 120, the processor 120 is provided to control data processing and related information processing, and output image information, an adhesive set on a bottom side of the base 1 is provided to attach the base 1 onto a windshield W.
a rotating module 2, which includes a fixed portion 21 and a rotating portion 22, the fixed portion 21 is fixedly connected to the base 1, the rotating module 2 is provided to rotate projected image corresponding to horizontal and vertical screen of a smartphone;
a display module 3, which is electrically connected to the circuit board 12, the display module 3 is fixedly connected to the rotating portion 22, the display module 3 is provided to receive images output from the circuit board 12 and project the images;
a reflective module 4, which is provided to reflect the images projected by the display module 3.

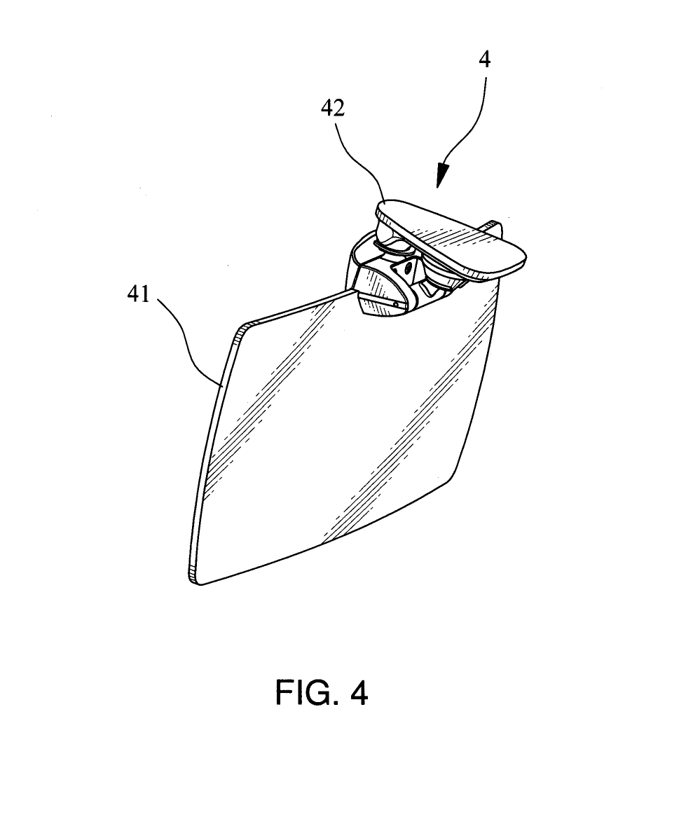

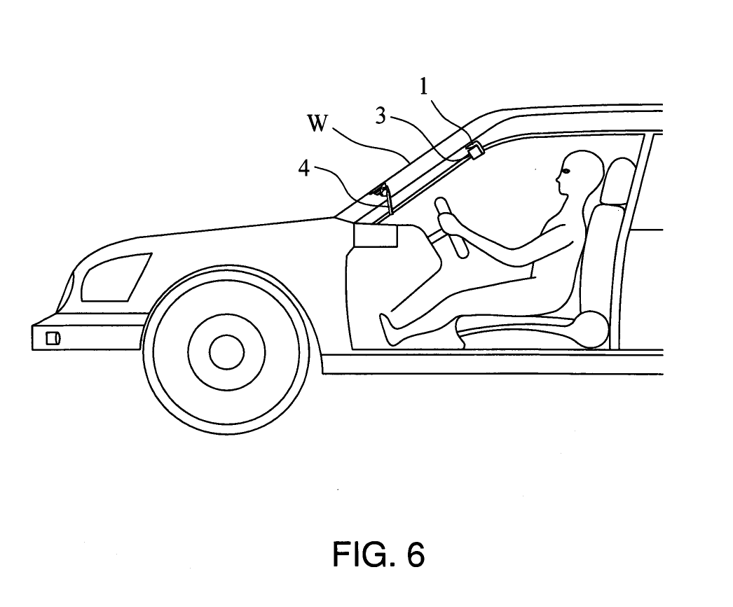

As shown in FIG. 4 and FIG. 6, the reflective module 4 includes a reflective sheet 41 and a base plate 42, the reflective sheet 41 is fixed on the base plate 42, wherein an adhesive set on a bottom side of the base plate 42 is attached onto a windshield W, the reflective sheet 41 is a concave mirror with translucent semi-reflective effect, the concave mirror is provided to enlarge a virtual image, let the distance of the virtual image become far at the same ratio and reflect and enlarge the images projected from the display module 3, so that the image may be overlapped with the view on the road ahead.

The reflective module 4 is a reflective film with translucent semi-reflective effect, which could be attach to the windshield W.

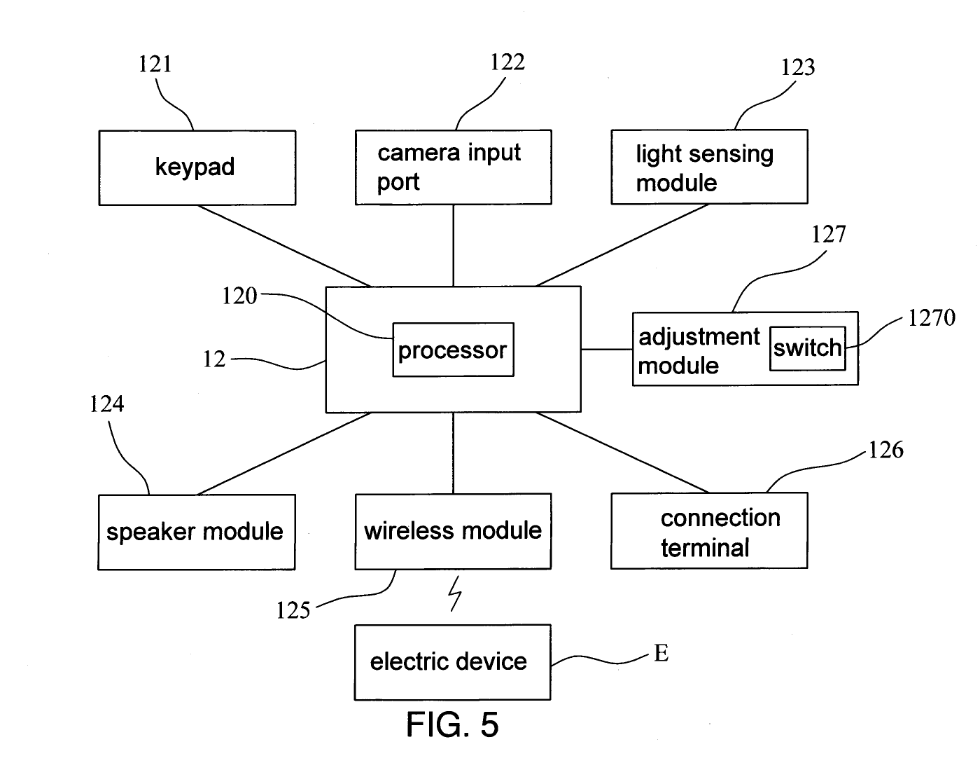

As shown in FIG. 5, the circuit board 12 further includes a keypad 121, the keypad 121 electrically connected to the circuit board 12 is provide to operate the rotating head-up display device.

As shown in FIG. 5, the circuit board 12 further includes a camera input port 122, the camera input port 122 is provided to connect to a front camera lens, a rear camera lens and a side camera lens set on a vehicle, to capture images around the vehicle and form a wide-angle panoramic image by image processing.

As shown in FIG. 5, the circuit board 12 further includes a light sensing module 123, the light sensing module 123 is provided to adjust brightness of the display module according to sensed light intensity, so that drivers may watch messages on the display module clearly.

As shown in FIG. 5, the circuit board 12 further includes a speaker module 124, the speaker module 124 is provided to inform drivers of voice messages, and play voice files send by the electric devices as a warning sound.

As shown in FIG. 5, the circuit board 12 further includes a wireless module 125, the wireless module 125 is provided to receive signal data wirelessly send from an electric device E, the wireless module 125 is a Bluetooth or a Wi-Fi; the electric device E is an in-vehicle device, a vehicle host, a vehicle audio system, a ceiling-attached multimedia player, headrest multimedia player, a hands-free device, a navigation device, a tire pressure detecting device, a smartphone, or a tablet; the electric device E may display vehicle speed if it is wirelessly connected to the electric device of the vehicle, displayed image information may be vehicle battery power, vehicle door is closed or not, trunk lip is closed or not, vehicle speed, road speed limits, navigation direction, vehicle tire pressure if it is a tire pressure detection device; the electric device E may display vehicle speed, and also display information send by a smartphone app if it is connected to the smartphone, wirelessly transferred to the wireless module 125 if the smartphone is provided to play music.

As shown in FIG. 5, the circuit board 12 further includes a connection terminal 126, the connection terminal 126 is provided to receive signal information send from an electric device E by cable, the connection terminal 126 could be a HDMI, OBD-II, a USB or a memory card slot interface for reading music or video information from the electric device E; the electric device E is an in-vehicle device, a vehicle host, a vehicle audio system, a ceiling-attached multimedia player, headrest multimedia player, a hands-free device, a navigation device, a smartphone, or a tablet; if the connection terminal 126 is OBD-II slot interface, it is provided to receive signal information send by vehicle computer.

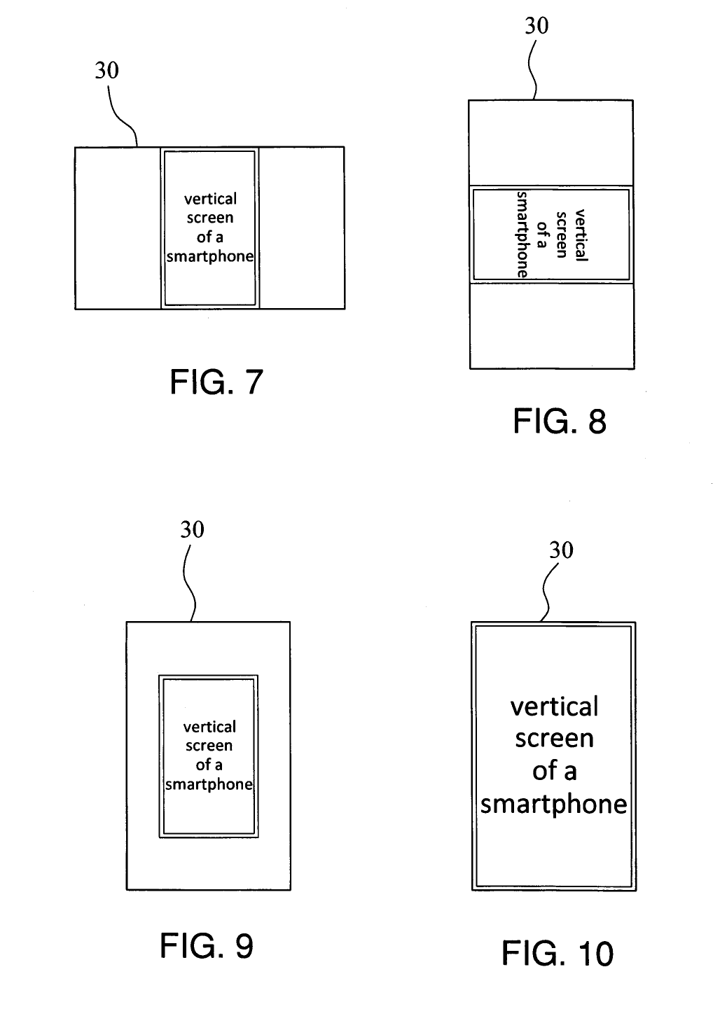

As shown in FIG. 5, the circuit board 12 further includes an adjustment module 127, the adjustment module 127 is provided to rotate and enlarge images after receiving a rotating signal, the adjustment module 127 further includes a switch 1270, which is provided to rotate horizontal and vertical screen of the smartphone, the operation is the same, the vertical screen is illustrated here as an example. The image 30 displayed on the display module 3 are shown in FIG. 1 to FIG. 3 and FIG. 7 to FIG. 10. As shown in FIG. 7, if the image send from the smartphone is vertical, the display module 3 should be rotate 90 degrees, the rotating module 2 may be rotated 90 degrees with it, at the time, the vertical image may also be rotated horizontal (as shown in FIG. 8), the switch 1270 sends a rotating signal, the adjustment module 127 rotates the vertical image to vertical (as shown in FIG. 9), and enlarge the rotated image simultaneously (as shown in FIG. 10), to thereby enlarge the vertical image displayed on the smartphone corresponding to the rotation of vertical (or horizontal) images of the smartphone.

What is claimed is:

1. A rotating head-up display device, including:
a base, a containing space is set inside it, and a circuit board is set on it;
a rotating module, which includes a fixed portion and a rotating portion, the fixed portion is fixedly connected to the base;
a display module, which is electrically connected to the circuit board, the display module is fixedly connected to the rotating portion, the display module is provided to project images;
a reflective module, which is provided to reflect the images projected by the display module.

2. The rotating head-up display device as claimed in claim 1, wherein the circuit board includes an adjustment module, the adjustment module is provided to rotate and enlarge images after receiving a rotating signal.

3. The rotating head-up display device as claimed in claim 1, wherein the reflective module is a reflective film with translucent semi-reflective effect.

4. The rotating head-up display device as claimed in claim 1, wherein the reflective module includes a reflective sheet and a base plate, the reflective sheet is fixed on the base plate, an adhesive set on a bottom side of the base plate is attached onto a windshield, the reflective sheet is a concave mirror with translucent semi-reflective effect.

5. The rotating head-up display device as claimed in claim 1, wherein the circuit board further includes a keypad, the keypad is provide to operate the rotating head-up display device.

6. The rotating head-up display device as claimed in claim 1, wherein the circuit board further includes a camera input port, the camera input port is provided to connect to a camera installed on a vehicle, to thereby capture images around the vehicle.

7. The rotating head-up display device as claimed in claim 1, wherein the circuit board further includes a light sensing module, the light sensing module is provided to adjust brightness of the display module.

8. The rotating head-up display device as claimed in claim 1, wherein the circuit board further includes a speaker module, the speaker module is provided to inform drivers of voice messages.

9. The rotating head-up display device as claimed in claim 1, wherein the circuit board further includes a wireless module, the wireless module is provided to receive signal data wirelessly send from an electric device.

10. The rotating head-up display device as claimed in claim 1, wherein the circuit board further includes a connection terminal, the connection terminal is provided to receive signal information send from an electric device by cable.
